(19) United States
(12) Patent Application Publication
(10) Pub. No.: US 2015/0039402 A1
(43) Pub. Date: Feb. 5, 2015

(54) WIRELESS MAINTENANCE MANAGEMENT MOBILE DEVICE APPLICATION PLATFORM AND RELATED SYSTEM

(71) Applicant: UBM LLC, Princeton Junction, NJ (US)

(72) Inventors: Sharad MADISON, Princeton Junction, NJ (US); Joseph SILVESTRI, Pennington, NJ (US); Harry LASTER, Fort Lee, NJ (US); Eliza WILSON, Rutherford, NJ (US); Juan MEJIA, Plainsboro, NJ (US)

(73) Assignee: UBM LLC, Princeton Junction, NJ (US)

(21) Appl. No.: 13/959,662

(22) Filed: Aug. 5, 2013

(51) Int. Cl. G06Q 10/06

(52) U.S. Cl. CPC G06Q 10/06398
USPC 705/7.42

(57) ABSTRACT

A mobile device application platform for maintenance management implemented by a personal digital assistant is provided by providing the user with access to a wireless connection, comprising: a repository of forms associated with a commercial cleaning system; a central server; a wireless communication system between the platform and the central server used to transmit data from the completed forms to the central server; and a central processer on the central server to analyze collected data to generate reports on any deficiencies and/or problems with the maintenance management; a related wireless maintenance management system is also provided.

This application claims the benefit of U.S. provisional application No. 61/680,023 filed Aug. 6, 2012, which is incorporated herein in its entirety by reference.

### FIELD OF THE INVENTION

The present invention relates to wireless maintenance management mobile device application and related system. In particular, the invention platform and system are used to produce reports which manage and measure day to day performance activity in real time as part of a commercial cleaning maintenance program.

### BACKGROUND OF THE INVENTION

Present commercial cleaning service programs include but are not limited to the following problems and difficulties:
Measuring and benchmarking the effectiveness and quality of work;
Employee accountability for cleanliness of job performance;
Handwritten service remarks may be lost, misread, illegible or misinterpreted;
Monitoring hours of remote workers and jobs completed; and
Paperwork can be time-consuming, taking away from hands-on service delivery.

The purpose of the wireless maintenance management mobile device application platform and system overcome these problems and difficulties and accomplish, but are not limited to, the following results:
Information retrieved is stored in a central secure data base;
The wireless platform is user friendly;
Reduction in paper circulated between companies;
Provides customers with easy access to make real time work orders regarding a variety of services;
Reduces carbon footprint;
Automated alerts of service completion;
Inspection reports record all notes and photos of deficiencies so they may be immediately addressed.

The present invention provides a wireless maintenance management system. In particular a commercial cleaning service system designed to measure the effectiveness and quality of work; employee accountability and cleanliness of job performance; monitoring hours of remote workers and jobs completed.

The information retrieved is stored in a secure central data base. The wireless platform is user friendly. The invention system provides customers with easy access to make real time work orders relating to a variety of systems. The invention provides a reduction in paperwork. Automated alerts are provided upon service completion. Inspection reports record all notes and photos of deficiencies so that they may be immediately addressed and corrected faster.

Representative of the prior art includes U.S. Pat. No. 8,090,462 B2 to Wininger et. al; U.S. Pat. No. 8,073,967 82 to Peterson et al.; U.S. Pat. No. 7,525,422 B2 to Bishop et al.; U.S. Pat. No. 7,426,654 B2 to Adams, Jr. et al.; U.S. Pat. No. 6,885,921 B1 to Farmer; U.S. Pat. No. 6,671,593 B2 to Sinex; U.S. Pat. No. 6,594,621 B1 to Meeker; and U.S. Patent Application Publication No. 2006/0161654 A1 to Hollingsworth, Jr. (all of which are incorporated herein by reference).

Prior art patents to Labedz et al. include U.S. Pat. Nos. 7.606,919 B2; 7,548,970 82; 6,993,576 B1 and U.S. Application Publication Nos. 2009/0327014 A1; 2008/0065456 A1 and 2006/0155815 A1 (all of which are incorporated herein by reference), which in general disclose systems and wireless methods for managing maintenance of building facilities. However, the difference between the invention system and those disclosed in the Labedz references is that they are web-based and require the use of a web browser for the user to create the work orders, inspections etc. For example, in order to use the software technology of Labedz et al. to create a work order, you will have to go to a specific website (ie. www.whateverthenameis.com)

In contrast, the invention system is wireless and the user does not need to access a website to submit work orders or inspections. The user only has access to the invention application on a mobile device. For example, to use the invention technology system to create a work order it is accessed through the application platform on the mobile device such as a handheld tablet or cell phone not thru a website.

The invention process does not depend on a website while the prior art Labedz technology does.

The invention provides the following advantages over the prior art and specifically the Labedz patent disclosures.

A general objective of the present invention is to provide a localized application platform specific to the mobile device that it is used on to utilize the system.

Another advantage of the invention is to provide an application method which functions separately from a website

Another objective of the invention is to provide an application platform that does not require an internet connection to function.

Another objective of the invention is to provide an application platform to enable a one-touch access to service.

A further objective of the invention process and system is to enable updates to be performed manually by each individual user.

Another objective of the invention is that there is no need to be connected to the internet to utilize the system.

Another objective of the invention is to provide access to the application platform on each handset used in the system.

Another objective of the invention is to make use of the features on the mobile device such as the phone, camera and geo-location features in the invention process.

### SUMMARY OF THE INVENTION

In the present invention, these purposes, as well as others which will be apparent, are achieved generally by providing a wireless inspection application platform for maintenance management implemented by a personal digital assistant (“PDA”). The term PDA and mobile device are used interchangeably herein in this specification and are meant to be equivalent terms.

The PDA provides the user with access to a wireless connection as well as access to the application platform which includes a repository of forms associated with a commercial cleaning system. The wireless communication system is used to transmit data from the application platform to a central server whereby reports are generated and any deficiencies and/or problems are addressed and corrected in less than 24 hours.

The applicant platform includes forms for supply delivery; employee warning; quality assurance inspection; periodic; window cleaning; branch and supervisors; vehicle inspection; employee absent; personal action; building deficiency and extra services. Other forms relating to a commercial cleaning system are encompassed by the invention and are intended to be included herein.

The invention also includes a wireless maintenance management system comprising the steps of providing a user log-in to wireless application platform on a personal digital assistant; providing a form menu for the user to select from the group consisting of a repository of forms associated with a commercial cleaning system; conducting a commercial cleaning program at a certain location; accessing and completing the forms in the repository; transmitting completed action data to a central server; analyzing the data and noting any deficiencies or problems; and correcting deficiencies or problems in under 24 hours.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a schematic diagram of the system according to the invention; and

FIG. 2 is a schematic diagram of the representative forms on the application platform accessible on the PDA and utilized in the system of the invention.

### DETAILED DESCRIPTION OF THE INVENTION

In accordance with the present invention a wireless inspection application platform for maintenance management implemented by a personal digital assistant (“PDA”) is provided.

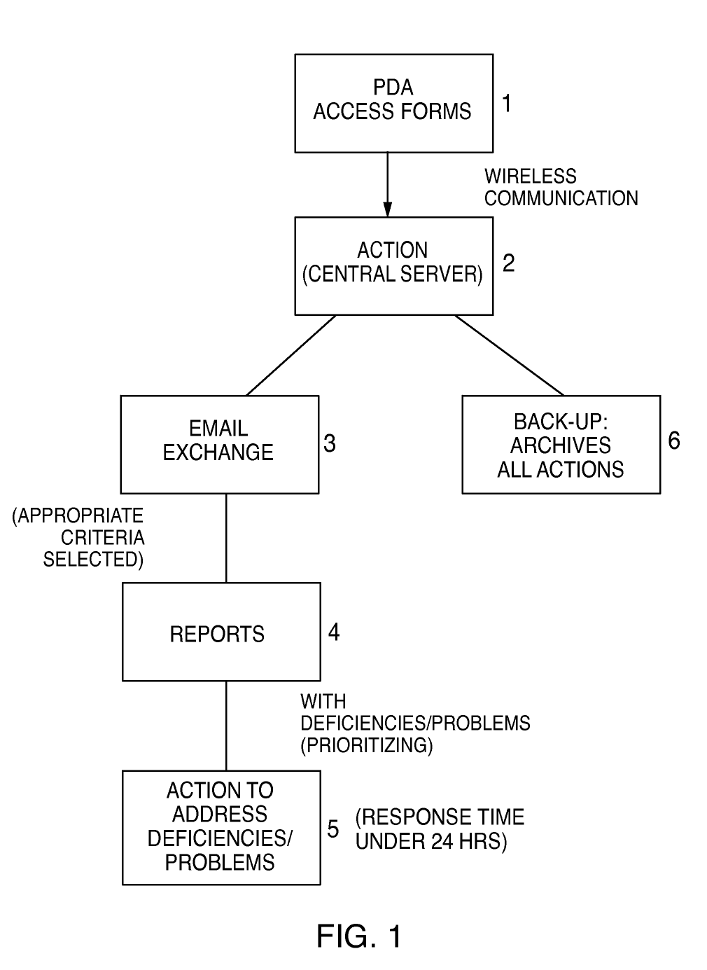

The general system is illustrated in FIG. 1. A PDA device includes an application platform with access to a repository of forms associated with a commercial cleaning system 1. Appropriate forms are completed on the application platform located on the PDA device. The PDA has a wireless communication system used to transmit data from the application platform to a central server 2 whereby reports 4 are generated and any deficiencies and/or problems 5 are addressed and corrected in under 24 hours.

The application platform provides a wireless communication means between the person completing the form and the central server 3. There is also an automatic back up or archive 6 of all actions completed and reported to the central server.

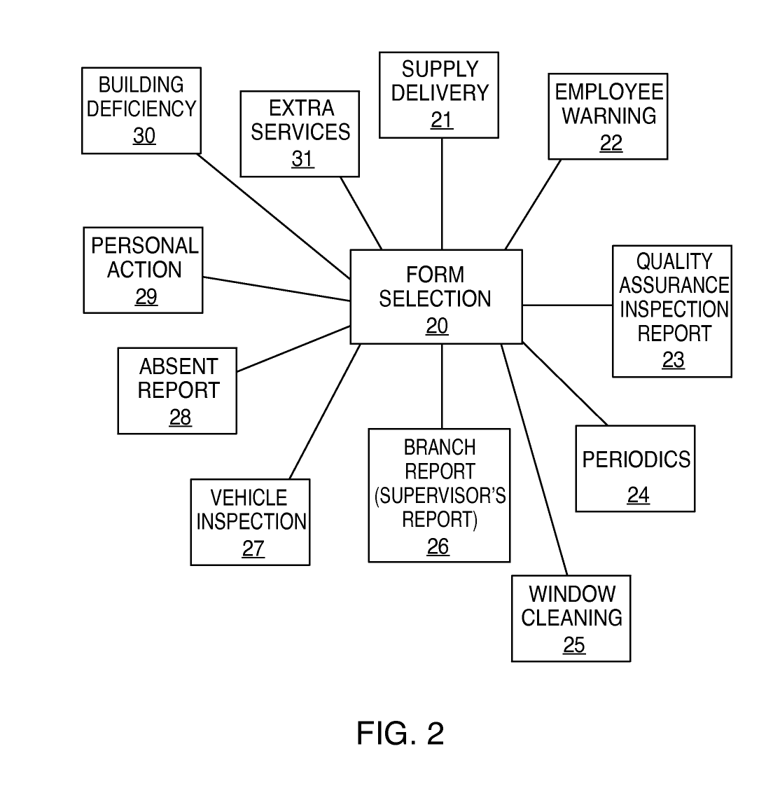

FIG. 2 illustrates a representative sample of the repository of forms 20 on the application platform of the invention. They include but are not limited to forms for supply delivery 21; employee warning 22; quality assurance inspection 23; periodic 24; window cleaning 25; branch and supervisors 26; vehicle inspection 27; employee absent 28; personal action 29; building deficiency 30 and extra service 31. Other actions and related forms pertaining to cleaning maintenance management can be used in the invention system.

The invention also provides a wireless maintenance management system utilizing the invention maintenance application platform. The system provides a user log-in to wireless application platform on a personal digital assistant with a form menu for the user to select from the group consisting of a repository of forms associated with a commercial cleaning system. Upon conducting a commercial cleaning program at a certain location the user can access and complete relevant forms in the repository. The data from the completed forms are transferred via the wireless communication network to a central server where they are reviewed. Any deficiencies or problems that require additional action can be corrected in less than 24 hours since the invention provides immediate notification.

In general, service delivery to the customer is facilitated by the invention system for providing meaningful real time quality reporting, which drives performance, accountability and continuous improvement strategies. The invention's utilization and integration of wireless services into a cleaning system provides reduced costs, reduced energy and maximizes resources.

Quality Assurance Reporting is designed to increase productivity, accountability, efficiency and reliability—while also being a paperless process. Within minutes of a quality assurance inspection, the report is easily accessible to multiple parties for review. Building inspection reviews are a significant part of measuring the success of the cleaning services program. This system allows for a healthy flow of information pertaining to service needs. The wireless inspection application platform of the invention, in conjunction with open lines of communication fosters a more efficient environment for service and correction.

New forms directed to service requirements by a specific customer, building or commercial cleaning program may be included in the invention system.

The business intelligence the reports provide allows timely decisions to be made as it relates to the delivery and performance commercial cleaning service program and the staff implementing the service. Having real-time information allows executives and staff the ability to evaluate the results of the service delivery program in a matter of minutes and can therefore identify issues and respond to them before they become a serious or repetitive problem for the customer.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A mobile device application platform for maintenance management implemented by a personal digital assistant providing the user with access to a wireless connection, comprising:
a repository of forms associated with a commercial cleaning system;
a central server;
a wireless communication system between the platform and said central server used to transmit data from the completed forms to said central server; and
a central processer on said central server to analyze collected data to generate reports on any deficiencies and/or problems with the maintenance management.

2. The mobile device application platform according to claim 1, wherein said central processer generates an email notification directly to the individual responsible to correct any deficiencies and/or problems.

3. The mobile device application platform according to claim 2, wherein the deficiencies and/or problems are corrected in less than 24 hours.

4. The mobile device application platform according to claim 1, wherein said forms include a form for supply delivery; employee warning; quality assurance inspection; periodic; window cleaning; branch and supervisors; vehicle inspection; employee absent; personal action; building deficiency and extra services.

5. The mobile device application platform according to claim 1, further comprising an icon on the mobile device whereby said forms are stored.

6. The mobile device application platform according to claim 1, wherein real time work orders for maintenance management are generated.

7. A wireless maintenance management system comprising the steps of:
providing a user log-in to wireless platform on a personal digital assistant;
providing a form menu within said platform for said user to select from the group consisting of a repository of forms associated with a commercial cleaning system;
conducting a maintenance cleaning at a selected location;
accessing said forms in the repository to collect data from the maintenance cleaning at the selected location;
communicating with a wireless network to transfer data from the wireless platform to a central server;
processing of the transferred data by a central processer; and
generating reports on deficiencies and/or problems with the maintenance management.

8. The wireless maintenance management system according to claim 7, wherein an email notification is generated from said central processer and sent directly to the individual responsible to correct any deficiencies and/or problems.

9. The wireless maintenance management system according to claim 8, wherein the deficiencies and/or problems are corrected in less than 24 hours.

10. The wireless maintenance management system according to claim 7, wherein said forms include a form for supply delivery; employee warning; quality assurance inspection; periodic; window cleaning; branch and supervisors; vehicle inspection; employee absent; personal action; building deficiency and extra services.

11. The wireless maintenance management system according to claim 7, wherein the system generates real time work orders.

12. The wireless maintenance management system according to claim 7, further comprising automated alerts generated by the central processer upon service completion.

13. The wireless maintenance management system according to claim 7, wherein inspection reports include notes on any deficiencies or problems.

14. The wireless maintenance management system according to claim 7, wherein inspection reports include photographs of any deficiencies or problems.

15. The wireless maintenance management system according to claim 7, further measuring the effectiveness and quality of the maintenance cleaning at the selected location.

16. The wireless maintenance management system according to claim 7, further measuring the cleanliness of the maintenance cleaning at the selected location.

17. The wireless maintenance management system according to claim 7, further providing for employee accountability of the maintenance cleaning at the selected location.

18. The wireless maintenance management system according to claim 7, further monitoring the hours of remote workers and maintenance cleaning at the selected location.
